(19) United States
(12) Patent Application Publication
(10) Pub. No.: US 2024/0329972 A1
(43) Pub. Date: Oct. 3, 2024

(54) UPDATE METHOD AND NON-TRANSITORY COMPUTER STORAGE MEDIA FOR SETTLEMENT TERMINAL

(71) Applicant: NIDEC INSTRUMENTS CORPORATION, Nagano (JP)

(72) Inventor: Ryoichi YOKOMIZU, Nagano (JP)

(73) Assignee: NIDEC INSTRUMENTS CORPORATION, Nagano (JP)

(21) Appl. No.: 18/624,058

(22) Filed: Apr. 1, 2024

(30) Foreign Application Priority Data
Apr. 3, 2023 (JP) 2023-060106

(51) Int. Cl. G06F 8/65; G06F 8/71

(52) U.S. Cl. CPC G06F 8/65; G06F 8/71

(57) ABSTRACT

By setting an update target program as a target program, an attachment confirmation step of confirming whether a recording medium is attached to a settlement terminal is executed. When the recording medium is not attached, first update data is downloaded from a program server via a network to execute an update When the recording medium is attached, second update data is downloaded from the recording medium to execute an update. The steps are executed by an application program.

### CROSS-REFERENCE TO RELATED APPLICATION

This application claims the benefit of Japan application serial no. 2023-060106, filed on Apr. 3, 2023. The entirety of the above-mentioned patent application is hereby incorporated by reference herein and made a part of this specification.

### BACKGROUND

### Field of the Invention

At least an embodiment of the present invention relates to a settlement terminal used in online payment or the like and, in particular, to an update method for a computer program such as firmware or an operating system (OS) in a settlement terminal and an application program that executes such an update method.

### Description of the Related Documents

A settlement terminal connected to a settlement server via a network is used to perform online payment at a sales location such as a store. The settlement terminal is configured, for example, as a so-called built-in computer device including a touch screen for input. Since an authentication medium such as a credit card, a prepaid card, or a two-dimensional code is often used in online payment, the settlement terminal may include a reader unit that reads data from the authentication medium, and may further include a display or the like provided independently of the touch screen. The settlement terminal has a minimum configuration for functioning as a computer, that is, a configuration in which a processor such as a central processing unit (CPU) that operates based on a program, a volatile memory such as a random access memory (RAM), and a non-volatile memory such as a read only memory (ROM) or a flash memory are mounted on a module board and the module board is attached to a main board. The main board is provided with an input/output (I/O) interface for connection to a network, a touch screen, or the like.

Since the settlement terminal is a computer device, a computer program (hereinafter, simply referred to as a “program”) such as firmware or an OS for operating the settlement terminal is necessary, and the program is written in the non-volatile memory. For improvement in function or the like, it is desired that the program already written in the settlement terminal can be rewritten to a new version of the program, that is, can be updated. However, from the viewpoint of ensuring security, the settlement terminal is often configured such that the module board cannot be removed from the main board, and it is difficult to directly write the new version of the program in the non-volatile memory after the module board is removed. Therefore, when the program is updated, the new version of the program is generally downloaded to the settlement terminal via a network such as a wired or wireless local area network (LAN), and the downloaded program is written in the non-volatile memory.

The processor of the settlement terminal executes an application program for update execution, and thus processing of downloading the new version of the program and storing the program in the non-volatile memory of the settlement terminal is performed. Chinese Patent Application Publication No. 112035146 discloses an application program for updating a program. U.S. Patent Application Publication No. 2019/0278583 discloses that, when firmware is updated, a set firmware update file is read in a memory to be arranged therein, a function entry address of the firmware update file is acquired, firmware update data is acquired from the firmware update file in the memory based on the function entry address, and the acquired firmware update data is written in a firmware module. In the following descriptions, a program to be updated is referred to as a target program. As described above, the target program is, for example, firmware or an OS, but the application program itself that executes the update may be the target program.

When a target program such as firmware or an OS is updated in a settlement terminal, a new version of the target program is often downloaded via a network and stored in a non-volatile memory. However, in some cases, the target program is desired to be updated without via the network. In such a case, the new version of the target program is stored in a portable recording medium such as a universal serial bus (USB) memory, and the recording medium is locally connected to the settlement terminal. Then, the new version of the target program is read out from the recording medium and written in the non-volatile memory. However, in updating via the network and updating via the portable recording medium, the operation procedure is different even except for whether or not the recording medium is locally connected, that is, attached to the settlement terminal, and updating via the portable recording medium cannot be easily performed.

An object of at least an embodiment of the present invention is to provide an update method by which a target program can be updated in the same procedure regardless of whether or not updating is performed via a network or a portable recording medium, and an application program for executing such an update method.

### SUMMARY

An update method of at least an aspect of the present invention is an update method for a program in a settlement terminal that is configured as a computer device comprising a processor that operates based on a program, a non-volatile memory, a volatile memory, and a display unit, the settlement terminal that executes online payment, the method including: by setting an update target program as a target program, an attachment confirmation step of confirming whether a recording medium is attached to the settlement terminal; a first confirmation step of confirming, when it is determined in the attachment confirmation step that the recording medium is not attached, whether first update data for a newer version of the target program than a version of the target program stored in the non-volatile memory is present in a program server accessible by the settlement terminal via a network; a first update step of starting first writing processing of downloading the first update data from the program server and writing the first update data in the non-volatile memory in accordance with an instruction from a user when the first update data is present; a second confirmation step of confirming, when it is determined that the recording medium is attached in the attachment confirmation step, whether second update data for a newer version of the target program than the version of the target program stored in the non-volatile memory is present in the recording medium; and a second update step of starting second writing processing of reading the second update data from the recording medium and writing the second update data in the non-volatile memory in accordance with an instruction from the user when the second update data is present, wherein when any one of the first writing processing and the second writing processing is being executed, the attachment confirmation step is not executed, and the attachment confirmation step, the first confirmation step, the first update step, the second confirmation step, and the second update step are executed by an application program that operates on the settlement terminal.

According to the update method of the aspect, the procedure of updating by downloading the first update data from the program server via the network and the procedure of updating with the use of the second update data stored in the recording medium attached to the settlement terminal can be unified. Updating from the recording medium attached to the settlement terminal can be easily performed in the same as updating via the network.

In the update method according to the aspect, the first writing processing is preferably processing by streaming update, and the second writing processing is preferably processing by non-streaming update. Updating via the network is the streaming update, and thus even when the free space of the non-volatile memory in the settlement terminal is small, the target program can be reliably updated.

In the update method according to the aspect, the recording medium is preferably a UMS device attached to the settlement terminal. By using the UMS device, the recording medium can be easily controlled from the settlement terminal side.

In the update method according to the aspect, a screen transition of a screen displayed on the display unit when the first confirmation step, the first update step, and the first writing processing are executed is preferably common to a screen transition of a screen displayed on the display unit when the second confirmation step, the second update step, and the second writing processing are executed. By applying the common screen transition, a user can execute the update work without regard to the difference between updating via the network and updating from the recording medium.

An application program of at least an aspect of the present invention is an application program that executes an update of a program in a settlement terminal that is configured as a computer device including a processor that operates based on a program, a non-volatile memory, a volatile memory, and a display unit, the settlement terminal that executes online payment, the application program allowing the processor to execute: by setting an update target program as a target program, an attachment confirmation step of confirming whether a recording medium is attached to the settlement terminal; a first confirmation step of confirming, when it is determined in the attachment confirmation step that the recording medium is not attached, whether first update data for a newer version of the target program than a version of the target program stored in the non-volatile memory is present in a program server accessible by the settlement terminal via a network; a first update step of starting first writing processing of downloading the first update data from the program server and writing the first update data in the non-volatile memory in accordance with an instruction from a user when the first update data is present; a second confirmation step of confirming, when it is determined that the recording medium is attached in the attachment confirmation step, whether second update data for a newer version of the target program than the version of the target program stored in the non-volatile memory is present in the recording medium; and a second update step of starting second writing processing of reading the second update data from the recording medium and writing the second update data in the non-volatile memory in accordance with an instruction from the user when the second update data is present, and the application program allowing the processor not to execute the attachment confirmation step when any one of the first writing processing and the second writing processing is being executed.

According to the application program of the aspect, the procedure of updating by downloading the first update data from the program server via the network and the procedure of updating with the use of the second update data stored in the recording medium attached to the settlement terminal can be unified. Updating from the recording medium attached to the settlement terminal can be easily performed in the same as updating via the network.

In the application program according to the aspect, the first writing processing is preferably processing by streaming update, and the second writing processing is preferably processing by non-streaming update. Updating via the network is the streaming update, and thus even when the free space of the non-volatile memory in the settlement terminal is small, the target program can be reliably updated.

In the application program according to the aspect, the recording medium is preferably a UMS device attached to the settlement terminal. By using the UMS device, the recording medium can be easily controlled from the settlement terminal side, and control on the recording medium from the application program can be easily performed.

In the application program according to the aspect, a screen transition of a screen displayed on the display unit when the first confirmation step, the first update step, and the first writing processing are executed is preferably common to a screen transition of a screen displayed on the display unit when the second confirmation step, the second update step, and the second writing processing are executed. By applying the common screen transition, a user can execute the update work without regard to the difference between updating via the network and updating from the recording medium.

According to the aspect of the present invention, when the target program is updated in the settlement terminal, the target program can be updated in the same procedure regardless of whether or not updating is performed via the network or via the portable recording medium.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a block diagram illustrating a configuration of a settlement terminal;

FIG. 2 is a flowchart for explaining processing of starting streaming update;

FIG. 3 is a diagram illustrating transition of screen displays in the settlement terminal;

FIG. 4 is a flowchart for explaining processing at the time of executing update; and

FIG. 5 is a flowchart for explaining processing at the time of executing an update.

### DESCRIPTION OF THE EMBODIMENTS

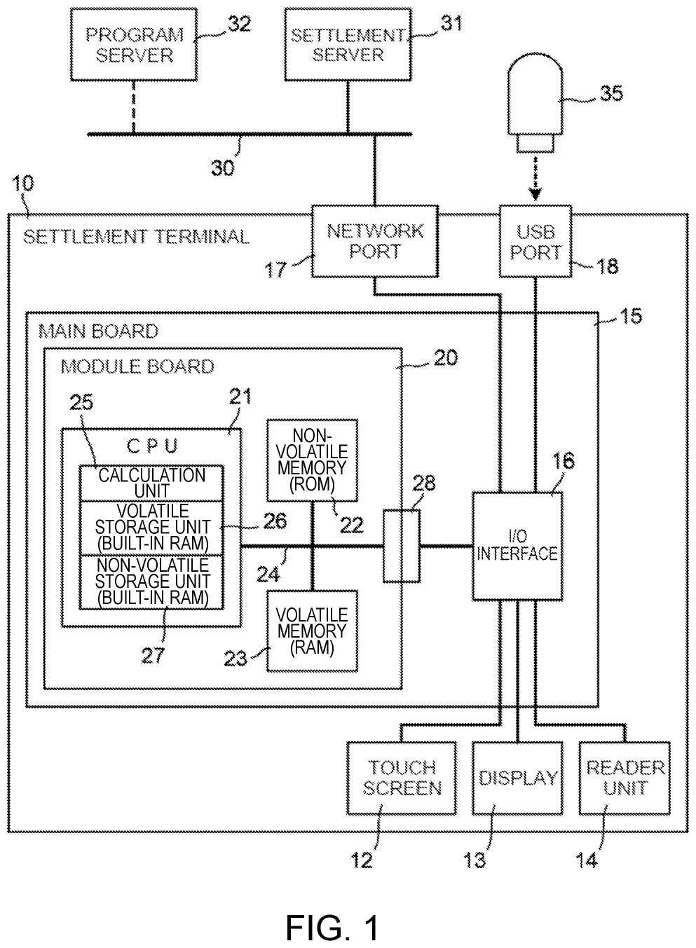

Next, modes for carrying out at least an embodiment of the present invention will be described. FIG. 1 is a block diagram illustrating a configuration of a settlement terminal to which an update method of an embodiment is applied. A settlement terminal 10 illustrated in FIG. 1 is used for executing online payment by connecting via a network 30 to a settlement server 31. The settlement terminal 10 may be configured to execute offline settlement processing while not being connected to the settlement server 31. The settlement terminal 10 includes a touch screen 12 that is operated by a finger or the like of a user for input, a display 13 that is provided independently of the touch screen 12 and presents information to a customer such as a consumer who uses a settlement service, and a reader unit 14 that reads data from an authentication medium. The touch screen 12 and the display 13 are display means. The authentication medium is, for example, a credit card, a prepaid card, or a two-dimensional code. When the authentication medium is a card medium such as a credit card or a prepaid card, the reader unit 14 is configured as a magnetic card reader or an IC card reader depending on whether the card medium is a magnetic card or an IC card. When the authentication medium is a two-dimensional code such as a QR code (registered trademark), the reader unit 14 is configured as a camera that reads the two-dimensional code. A smartphone, a smart watch, or the like that performs non-contact short-range communication can also be used as the authentication medium. When such an authentication medium is used, a reader unit suitable for such an authentication medium is used as the reader unit 14. Obviously, the reader unit 14 is preferably configured to be compatible with a plurality of types of authentication media.

The settlement terminal 10 is further provided with a network port 17 serving as a connection port with the network 30, and a USB port 18 to which various USB devices are attachably and detachably connected. The network port 17 may be a wireless LAN port for connecting to the network 30 that is a wireless LAN, or may be an Ethernet (registered trademark) port for connecting via a LAN cable to the network 30.

A main board 15 is disposed inside a main body of the settlement terminal 10. An I/O interface 16 is disposed on the main board 15, and a module board 20 is attached to the main board 15. Since the settlement terminal 10 is a computer device, the module board 20 is provided with a minimum configuration for functioning as a computer device, that is, a CPU 21, a non-volatile memory 22, and a volatile memory 23 configured by a RAM or the like to function as a main storage device that connects to the CPU 21. The CPU 21 is a processor that operates based on a program, and a microprocessor, a micro processing unit (MPU), or the like may be used instead of the CPU 21. The non-volatile memory 22 is configured by a rewritable ROM or a flash memory. Firmware, an OS, various application programs, or the like for operating the settlement terminal 10 are also stored in the non-volatile memory 22. The non-volatile memory 22 also functions as an external storage device in the settlement terminal as a computer device. In the module board 20, the CPU 21, the non-volatile memory 22, and the volatile memory 23 are connected to each other via an internal bus 24. The CPU 21 has a one chip configuration, and includes a volatile storage unit (built-in RAM) 26 that is a very small-capacity volatile storage area, and a non-volatile storage unit 27 (built-in ROM) that is a very small-capacity non-volatile storage area, in addition to a calculation unit 25 generally disposed in a CPU or microprocessor.

The module board 20 is electrically connected to the main board 15 via a connection portion 28, and thus the internal bus 24 of the module board 20 is also electrically connected to the I/O interface 16 on the main board 15. The I/O interface 16 constitutes an interface for the touch screen 12, the display 13, the reader unit 14, the network port 17, and the USB port 18. In the settlement terminal 10, the module board 20 may be detachable from the main board 15 by using a pair of connectors to the connection portion 28. However, in order to improve security in the settlement terminal 10, the module board 20 is preferably soldered to the main board 15 in the connection portion 28 so that the module board 20 and the main board 15 are not easily separated from each other.

In the present specification, regarding a target program stored in the non-volatile memory 22 of the settlement terminal 10, an expression such as “new version” or “updated version” is used, and this means a version newer than the version of the target program stored in the non-volatile memory 22 at that point.

Before describing updates of the target program in the settlement terminal 10, a general update method in various computer devices will be described. When a target program such as firmware or an OS stored in a non-volatile memory is updated in a computer device, in general, the entire program data of a new version of the target program is temporarily stored in a RAM, and then the update data in the RAM is copied to the non-volatile memory. Such an update mode is called non-streaming update. In the non-streaming update, it is assumed that free space for storing the entire update data is present in the RAM. Accordingly, disadvantageously, when the free space of the RAM is small, update cannot be performed. Therefore, an update mode has been proposed in which, when updating is performed via a network, update data is assumed to include a plurality of blocks or fragments, the blocks (or fragments) are downloaded one by one and stored in a RAM and the blocks (or fragments) stored in the RAM are copied to a non-volatile memory in each case. Such an update mode is called streaming update. The streaming update requires the following points that the program server 32 for distributing the update data is connected to the network 30 and that the computer device intended to perform update can access the program server 32 via the network 30. Note that a new version of program data used to update the target program is referred to as update data or a new version of update data.

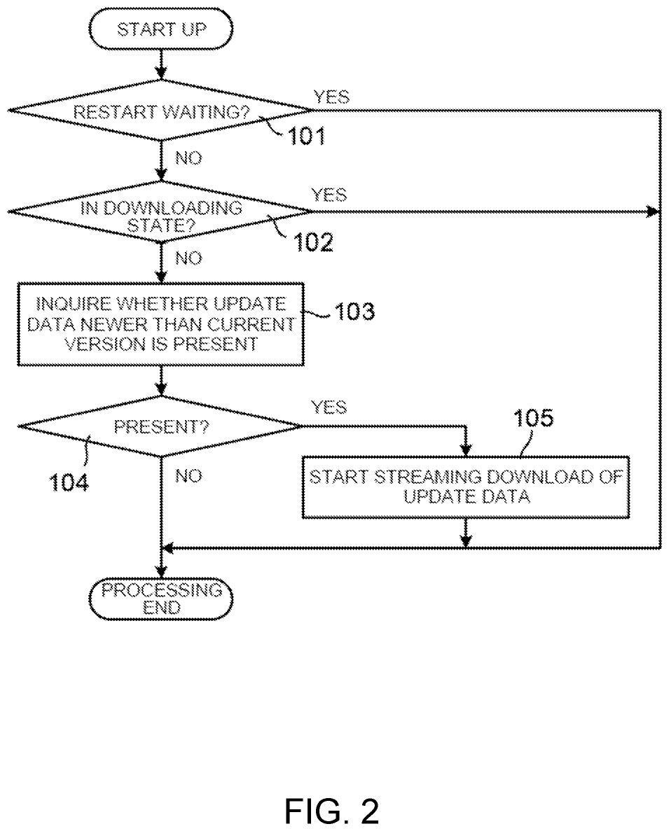

Although the streaming update itself is prepared as a function of the OS, an application program that operates on the OS intervenes when the streaming update is started. The application program may be activated by the OS at predetermined time intervals, or may be activated manually. The flowchart illustrated in FIG. 2 describes processing performed by the application program that starts the streaming update. First, in step 101, it is determined whether the copying of update data by the streaming update to the non-volatile memory 22 has been completed and the computer device is waiting for restart (reboot). At the time of waiting for restart, it is not necessary to restart the streaming update again, and thus the processing ends as it is. At the time of not waiting for restart in step 101, whether the update data is being downloaded is determined in step 102. Here, even when downloading is in progress, it is not necessary to restart the streaming update again, and thus the processing ends as it is.

When it is determined in step 102 that downloading is not in progress, the program server 32 is inquired in step 103 via the network 30 as to whether a new version of the update data is present. In step 104, whether the update data is present in the program server 32 is determined based on the result of this inquiry. Here, when the update data is not present, the processing ends as it is. When the update data is present, in step 105, the download of the update data by the streaming update, that is, the streaming download is started, and then the processing ends. On the other hand, when there is no update data in step 105, the processing ends as it is. In the processing described above, the processing of step 101 and the processing of step 102 may be executed in reverse order.

Next, the update of a target program such the firmware or the OS of the settlement terminal 10 according to the present embodiment will be described. An update method of the present embodiment is based on downloading update data from the program server 32 via the network 30 to the settlement terminal 10 by the aforementioned streaming update and writing the update data in the non-volatile memory 22. Therefore, the OS of the settlement terminal 10 is preferably an OS that supports the streaming update. Specifically, for example, when the OS is Android (registered trademark), the OS is preferably version 8 or later. Obviously, it is not essential to support the streaming update, and when the update data is downloaded via the network 30 to the settlement terminal 10, a non-streaming update mode may be used.

In the present embodiment, for the case where the update data cannot be downloaded via the network 30, the update data is read into the settlement terminal 10 from a portable recording medium attached via the USB port 18, i.e., locally connected to the settlement terminal 10, and thereby the target program on the non-volatile memory 22 can be updated. The update via the network 30 cannot be performed, for example, when the settlement terminal 10 is not connected to the network 30, when the program server 32 is not connected to the network 30, or when the program server 32 is connected to the network 30 but the settlement terminal 10 connected to the network 30 is not permitted to connect to the program server 32. In any case, the settlement terminal 10 cannot access the program server 32. In addition, the portable recording medium is used to allow the settlement terminal 10 to read a newer version of update data than the update data provided by the program server 32.

The portable recording medium connected to the USB port 18 is specifically a USB memory 35 attachably and detachably connected, that is, attached to the USB port 18. The USB memory 35 is treated as a UMS device, that is, a device of a USB-MSC (Mass Storage Class) from the OS side of the settlement terminal 10. In the present embodiment, the target program of the settlement terminal 10 can be updated by the same procedure at the time of updating via the network 30 and at the time of updating from the USB memory 35.

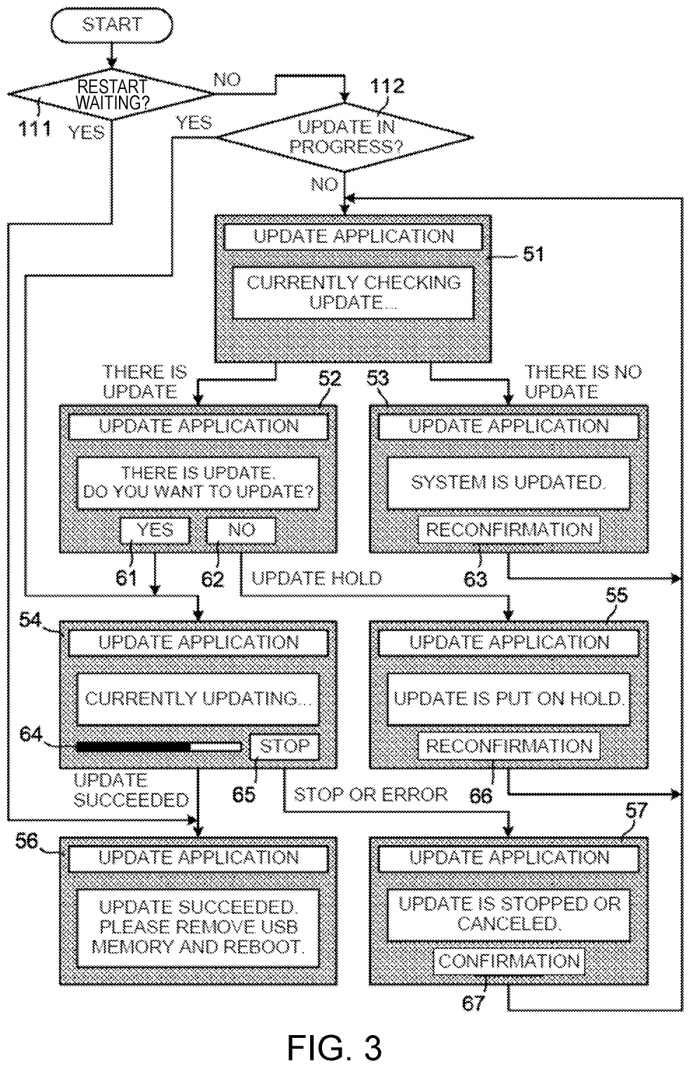

FIG. 3 illustrates transition of screen displays on the touch screen 12 of the settlement terminal 10 when the target program such as the firmware or the OS is updated in the settlement terminal 10. In the present embodiment, an application program (hereinafter, referred to as an “update app”) for updating the target program in the settlement terminal 10 is prepared. The update app is a computer program executed under the control of the OS in the calculation unit 25 of the settlement terminal 10, and controls downloading and reading of update data and writing of the update data into the non-volatile memory 22.

When the update app is activated, the update app first determines in step 111 whether the settlement terminal 10 is waiting for restart after the update. When the settlement terminal 10 is waiting for restart, the update has already succeeded at that time; therefore, a restart request screen 56 that notifies a user that the update has succeeded and prompts the user to restart the terminal is displayed. When the update has been performed from the USB memory 35, a message that prompts the user to remove the USB memory 35 is also displayed on the restart request screen 56. On the other hand, when determining in step 111 that the terminal is not waiting for restart, the update app determines in step 112 whether update is in progress. Here, the update data being in progress means that when the update is a streaming update mode, the download of the update data is in progress, and means that when the update is a non-streaming update, the download or reading of the update data is in progress or writing of the downloaded or read update data into the non-volatile memory 22 is in progress. Step 111 corresponds to step 101 illustrated in FIG. 2, and step 112 is obtained by modifying step 102 of FIG. 2 so as to be adapted to the update method of the present embodiment.

When determining in step 112 that the update is in progress, the update app displays a progress status notification screen 54 (also referred to as a progress screen) that indicates the progress of the update. On the progress status notification screen 54, an indicator 64 that indicates the progress status of the update in the form of a bar graph and a “stop” button 65 for ending the update processing are displayed. When the progress status notification screen 54 is displayed and then the update is completed, the restart request screen 56 is displayed in order to prompt restart. When the “stop” button 65 is pressed or clicked while the progress status notification screen 54 is displayed, an error display dialogue 57 that notifies that the update is stopped or canceled due to error is displayed. A “confirmation” button 67 is displayed in the error display dialogue 57. When the “confirmation” button 67 is pressed or clicked, an update confirming screen 51 is displayed that indicates whether a newer version of the target program than that stored in the non-volatile memory 22 is present, that is, whether update data is present is currently being confirmed.

When it is determined in step 112 that the update is not in progress, the update confirming screen 51 is displayed. The update confirming screen 51 is displayed when the update app confirms the presence or absence of the update data as in step 103 in the flowchart illustrated in FIG. 2. When it is confirmed that the update data is not present, a notification screen 53 that notifies that the update data is not present, that is, the system is updated is displayed. A “reconfirmation” button 63 is displayed on the notification screen 53. When the “reconfirmation” button 63 is pressed or clicked, the update app confirms again whether there is a new version of the update data; therefore, the update confirming screen 51 is displayed again.

When the update data is present after the update app has confirmed the presence or absence of the update data, the screen transitions from the update confirming screen 51 to an update start confirmation dialogue 52 that inquires the user whether to start the update. In the update start confirmation dialogue 52, a “Yes” button 61 for instructing the start of the update and a “No” button 62 for holding the update are displayed. When the “YES” button 61 is pressed or clicked, the download or reading of the update data is started, and the progress status notification screen 54 is displayed. On the other hand, when the “No” button 62 is pressed or clicked, an update hold notification screen 55 that indicates that the update is put on hold is displayed. The “reconfirmation” button 63 is displayed on the update hold notification screen 55. When the “reconfirmation” button 63 is pressed or clicked, the update app confirms again whether there is a new version of the update data, and thus the update confirming screen 51 is displayed again.

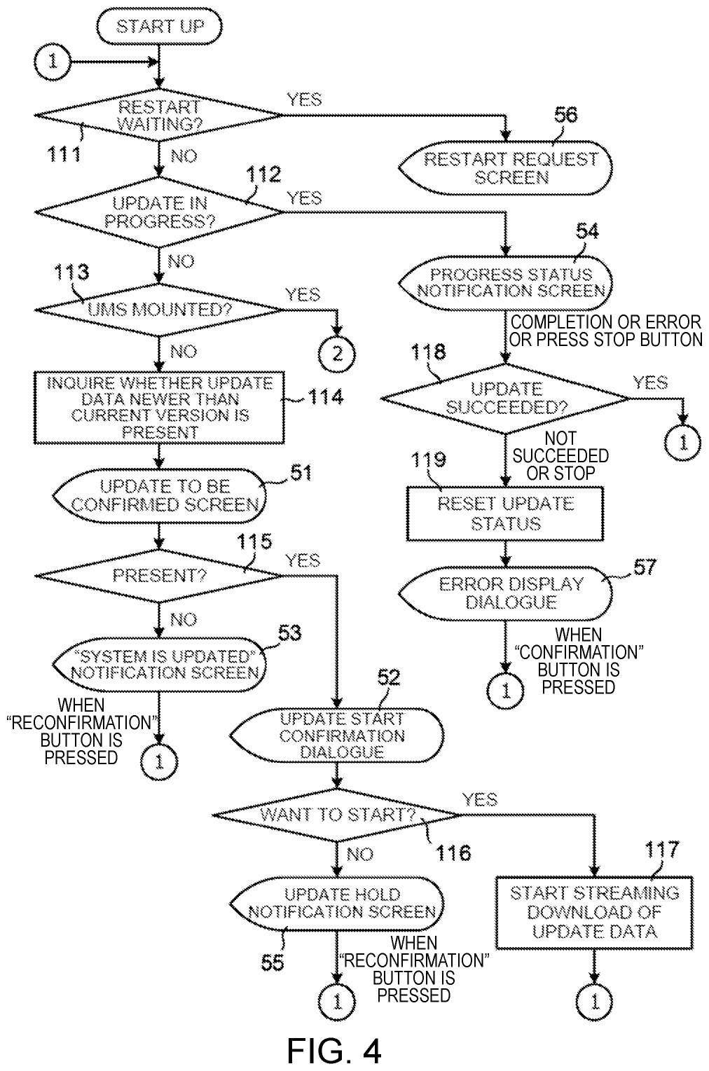

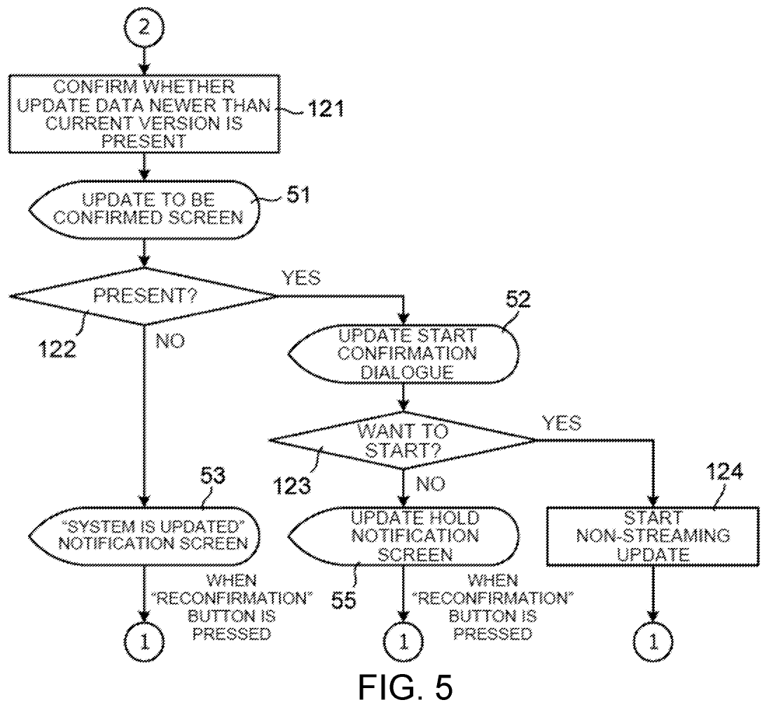

The processing of the update app for updating the target program with the screen transition described above will be described with reference to the flowcharts of FIGS. 4 and 5. First, when the update app is activated in the settlement terminal 10, the update app determines as described above in step 111 whether the settlement terminal 10 is waiting for restart after the update. When the terminal is waiting for restart, the update has already succeeded at that time; therefore, the restart request screen 56 that notifies the user that the update has succeeded and prompts the user to restart the terminal is displayed. When the terminal is not waiting for restart, the update app determines in step 112 whether update is currently in progress. When the update is not in progress in step 112, the update app then determines in step 113 whether the USB memory 35 is attached as the UMS device to the settlement terminal 10. Depending on the OS used by the settlement terminal 10, the update app may not be able to access the UMS device, that is, the USB memory 35 when the USB memory 35 is already attached to the settlement terminal 10 and used by another application program. Therefore, when the target program is updated, the USB memory 35 is preferably attached after the update app is activated. As is apparent from the flowcharts illustrated in FIGS. 4 and 5, as long as a newer version of the update data is stored in the USB memory 35, even when the USB memory 35 is attached to the settlement terminal 10 after the update app is activated, the settlement terminal 10 is updated by the newer version of the update data than that of the update data stored in the USB memory 35.

When determining in step 113 that the UMS device is not attached, the update app inquires, in step 114, of the program server 32 whether a newer version of the target program than the version of the target program in the settlement terminal 10 is present, and displays the update confirming screen 51 on the touch screen 12. Then, the update app determines based on the response to the inquiry in step 115 whether the new version of the update data is present in the program server 32. When the settlement terminal 10 cannot access the program server 32, it is regarded that the new version of the update data is not present. When determining as “not present” in step 115, the update app displays the notification screen 53 indicating that the system is updated. When the “reconfirmation” button 63 is pressed or clicked on the notification screen 53, the update app repeats the processing from step 111. At this time, when the terminal is not waiting for restart, the download is not in progress, and the USB memory 35 is not attached, the update app executes step 114 again. Therefore, the update confirming screen 51 is displayed. Note that steps 114 and 115 are respectively steps of performing the same processing as steps 103 and 104 in FIG. 2.

When determining as “present” in step 115, the update app displays the update start confirmation dialogue 52 and waits until either the “Yes” button 61 or the “No” button 62 in the update start confirmation dialogue 52 is pressed or clicked. When either one of the buttons 61 and 62 is operated, the update app determines, in step 116, which button is operated, that is, whether the start of the update is instructed. When the “Yes” button 61 is operated, the update app starts the streaming download of the update data from the program server 32 and starts the update in step 117, and then repeats the processing from step 111. Step 117 is a step corresponding to step 105 in FIG. 2. On the other hand, when determining in step 115 that the “No” button 61 is operated, the update app displays the update hold notification screen 55. Then, when a “reconfirmation” button 66 is operated on the update hold notification screen 55, the update app repeats the processing from step 111. In addition, when the user intends to perform updating from the USB memory 35, the USB memory 35 is attached to the settlement terminal 10 at the time when the update start confirmation dialogue 52 is displayed, and then the “No” button 61 is operated. Thus, when the processing from step 111 is repeated, it is determined in step 113 that the UMS device is attached, and therefore, updating by the update data stored in the USB memory 35 is performed as described below.

When the upload is in progress in step 112, the update app displays the progress status notification screen 54. Then, in any of the cases where the download is completed and the update is completed, where cancellation of the download or the update occurs due to occurrence of an error, and where an operation is performed on the “stop” button 65 in the progress status notification screen 54, the update app determines in step 118 whether the update has succeeded. When determining that the update has succeeded, the update app repeats the processing from step 111. On the other hand, when determining in step 118 that the update has failed, the update app resets the update state in the settlement terminal 10 in step 119 and then displays the error display dialogue 57. When the “confirmation” button 67 in the error display dialogue 57 is operated, the update app repeats the processing from step 111.

When determining in step 113 that the UMS device is attached, the update app confirms in step 121 whether there is a newer version of the update data than the version of the current target program in the UMS device, that is, the USB memory 35, and displays the update confirming screen 51. Step 122 indicates a branch based on the result obtained by the confirmation in step 121, and when the new version of the update data is present in the USB memory 35, the update app displays the update start confirmation dialogue 52. Then, the update app determines in step 123 whether any of the buttons 61 and 62 in the update start confirmation dialogue 52 is operated as in step 116. When the “Yes” button 61 is operated, the update app starts, in step 124, the non-streaming update of the update data stored in the USB memory 35, and then repeats the processing from step 111. On the other hand, when the “No” button 62 is operated in step 123, the update app displays the update hold notification screen 55. When the “reconfirmation” button 66 in the update hold notification screen 55 is operated, the update app repeats the processing from step 111.

The procedure of updating the target program such as the firmware or the OS of the settlement terminal 10 according to the present embodiment has been described above. The transition of images that appear on the touch screen 12 of the settlement terminal 10 when the target program is updated by the update app is the same in each case where the streaming update (non-streaming update in some cases) is performed via the network 30 and where the non-streaming update is performed via the USB memory 35 attached as the UMS device to the settlement terminal 10. Also, as will become apparent from the correspondence relationship between steps 114 to 117 illustrated in FIG. 4 and steps 121 to 124 illustrated in FIG. 5, except for the operation of attaching the USB memory 35, the user must perform the same operation from the activation of the update app to the completion of the update in each case where the target program is updated by downloading the update data via the network 30 and where updating is performed with the use of the update data in the USB memory 35 attached to the settlement terminal 10. In other words, according to the present embodiment, the target program can be updated in the settlement terminal 10 by the same procedure, and updating can be easily performed.

Additionally, in the present embodiment, when the USB memory 35 is attached to the settlement terminal 10 after the update app is activated, it is determined in step 113 that the UMS device is attached when the processing from step 111 is repeated, and the processing after step 121 is executed. Therefore, the update data is downloaded via the network 30 and updating is performed, and even thereafter, as long as a newer version of the update data is stored in the USB memory 35, updating is performed by the update data in the USB memory 35. In other words, finally, the target program such as the firmware or the OS of the settlement terminal 10 is updated by a newer version of the update data among the update data stored in the program server 32 and the update data stored in the USB memory 35.

What is claimed is:

1. An update method for a program in a settlement terminal that is configured as a computer device comprising a processor that operates based on a program, a non-volatile memory, a volatile memory, and a display unit, the settlement terminal executing online payment,
the update method comprising:
by setting an update target program as a target program,
attachment confirmation of confirming whether a recording medium is attached to the settlement terminal;
first confirmation of confirming, when it is determined in the attachment confirmation that the recording medium is not attached, whether first update data for a newer version of the target program than a version of the target program stored in the non-volatile memory is present in a program server accessible by the settlement terminal via a network;
first update of starting first writing processing of downloading the first update data from the program server and writing the first update data in the non-volatile memory in accordance with an instruction from a user when the first update data is present;
second confirmation of confirming, when it is determined that the recording medium is attached in the attachment confirmation, whether second update data for a newer version of the target program than the version of the target program stored in the non-volatile memory is present in the recording medium; and
second update of starting second writing processing of reading the second update data from the recording medium and writing the second update data in the non-volatile memory in accordance with an instruction from the user when the second update data is present,
wherein when any one of the first writing processing and the second writing processing is being executed, the attachment confirmation is not executed, and
the attachment confirmation, the first confirmation, the first update, the second confirmation, and the second update are executed by an application program that operates on the settlement terminal.

2. The update method according to claim 1, wherein the first writing processing is processing by streaming update, and the second writing processing is processing by non-streaming update.

3. The update method according to claim 2, wherein the recording medium is a UMS device attached to the settlement terminal.

4. The update method according to claim 2, wherein a screen transition of a screen displayed on the display unit when the first confirmation, the first update, and the first writing processing are executed is common to a screen transition of a screen displayed on the display unit when the second confirmation, the second update, and the second writing processing are executed.

5. The update method according to claim 1, wherein the recording medium is a UMS device attached to the settlement terminal.

6. The update method according to claim 1, wherein a screen transition of a screen displayed on the display unit when the first confirmation, the first update, and the first writing processing are executed is common to a screen transition of a screen displayed on the display unit when the second confirmation, the second update, and the second writing processing are executed.

7. A non-transitory computer storage media, storing an application program that executes an update of a program in a settlement terminal that is configured as a computer device comprising a processor that operates based on a program, a non-volatile memory, a volatile memory, and a display unit, the settlement terminal executing online payment,
the application program allowing the processor to execute:
by setting an update target program as a target program,
attachment confirmation of confirming whether a recording medium is attached to the settlement terminal;
first confirmation of confirming, when it is determined in the attachment confirmation that the recording medium is not attached, whether first update data for a newer version of the target program than a version of the target program stored in the non-volatile memory is present in a program server accessible by the settlement terminal via a network;
first update of starting first writing processing of downloading the first update data from the program server and writing the first update data in the non-volatile memory in accordance with an instruction from a user when the first update data is present;
second confirmation of confirming, when it is determined that the recording medium is attached in the attachment confirmation, whether second update data for a newer version of the target program than the version of the target program stored in the non-volatile memory is present in the recording medium; and
second update of starting second writing processing of reading the second update data from the recording medium and writing the second update data in the non-volatile memory in accordance with an instruction from the user when the second update data is present, and
the application program allowing the processor not to execute the attachment confirmation when any one of the first writing processing and the second writing processing is being executed.

8. The non-transitory computer storage media according to claim 7, wherein the first writing processing is processing by streaming update, and the second writing processing is processing by non-streaming update.

9. The non-transitory computer storage media according to claim 8, wherein the recording medium is a UMS device attached to the settlement terminal.

10. The non-transitory computer storage media according to claim 8, wherein a screen transition of a screen displayed on the display unit when the first confirmation, the first update, and the first writing processing are executed is common to a screen transition of a screen displayed on the display unit when the second confirmation, the second update, and the second writing processing are executed.

11. The non-transitory computer storage media according to claim 7 wherein the recording medium is a UMS device attached to the settlement terminal.

12. The non-transitory computer storage media according to claim 7, wherein a screen transition of a screen displayed on the display unit when the first confirmation, the first update, and the first writing processing are executed is common to a screen transition of a screen displayed on the display unit when the second confirmation, the second update, and the second writing processing are executed.
